(19) United States
(12) Patent Application Publication
(10) Pub. No.: US 2017/0185785 A1
(43) Pub. Date: Jun. 29, 2017

(54) SYSTEM, METHOD AND APPARATUS FOR DETECTING VULNERABILITIES IN ELECTRONIC DEVICES

(71) Applicant: IOTA SECURITY INC., North York (CA)

(72) Inventors: Yaron VORONA, North York (CA); Daniel THANOS, Stouffville (CA); Ofer SHAI, Toronto (CA); Jeremy Boyd RICHARDS, Oakville (CA); Richard KRUEGER, Bellevue, WA (US)

(21) Appl. No.: 15/326,391

(22) PCT Filed: Jul. 14, 2015
(86) PCT No.: PCT/IB2015/055326

§ 371 Date: Jan. 13, 2017

Related U.S. Application Data
(60) Provisional application No. 62/024,064, filed on Jul. 14, 2014.

(51) Int. Cl. G06F 21/57; G06N 99/00; G08B 21/18; G06F 21/56

(52) U.S. Cl. CPC G06F 21/577; G06F 21/566; G06N 99/005; G08B 21/182; G06F 2221/033

(57) ABSTRACT

A system and method are provided for detecting malicious or unwanted software, or malicious or unauthorized access to cyber-physical system devices. The activity and applications on the device are analyzed by various methods including machine learning algorithms and the results are reported. Malicious or unwanted 5 activity or applications can be stopped by the device user or other authorized person.

### CROSS-REFERENCE TO RELATED APPLICATION

This application claims priority from U.S. provisional patent application No. 62/024064, filed Jul. 14, 2014, the contents of which is incorporated herein by reference.

### FIELD

The specification relates generally to vulnerabilities in electronic devices. More particularly, the specification relates to a system, method and apparatus for detecting vulnerabilities in electronic devices.

### BACKGROUND

The National Institute for Science and Technology notes that all cyber-physical systems (CPS) “have computational processes that interact with physical components . . . Robots, intelligent buildings, implantable medical devices, cars that drive themselves or planes that automatically fly in a controlled airspace—these are all examples of CPS.”

The trustworthiness of cyber-physical system devices and other electronic devices is under increasing pressure. The number of electronic devices that are able to connect to other devices, either directly or through networks is rapidly increasing. International security and economic prosperity depends on the reliable functioning of all devices in an increasingly interconnected world. Security is defined by the ISO/IEC 27000:2009 standard as

“Preservation of confidentiality, integrity and availability of information. Note: In addition, other properties, such as authenticity, accountability, non-repudiation and reliability can also be involved.” It is thus desirable for all stakeholders to ensure the availability, integrity and confidentiality of information systems, including cyber-physical systems.

Risks to information systems and cyber-physical system devices can arise from inadvertent compromises as a result of user errors, component failures and vulnerable programs, as well as deliberate attacks by disgruntled individuals, agents of industrial espionage, foreign military personnel, terrorist groups, and criminals. The impacts can be theft of secrets, theft of money, fraud, destruction of critical infrastructure and threats to national security. Security measures can be taken to mitigate the risk of these risks, as well as to reduce their impact.

The National Institute for Standards and Technology (NIST) recommends that “devices should implement the following three mobile security capabilities to address the challenges with mobile device security: device integrity, isolation, and protected storage.” Mobile devices are an example of a cyber-physical system, and so other cyber-physical systems may benefit from the same approach.

Cyber-physical system devices generally have at least one wireless network interface for network access (data communications), which uses Wi-Fi, cellular networking, or other technologies that connect the cyber-physical device to network infrastructures with connectivity to the Internet or other data networks; Local built-in (non-removable) data storage; and an operating system that is not a full-fledged desktop or laptop operating system. Some also have applications available through multiple methods (provided with the device, accessed through web browser, or acquired and installed from third parties).

Many cyber-physical systems are not capable of providing strong security assurances to end users and organizations. These systems often need additional protection because their nature generally places them at higher exposure to threats than traditional computers.

Current security solutions for cyber-physical system devices like smart mobile phones do not provide sufficient protections against more advanced threats, which may include obfuscated malicious software, exploitation of vulnerabilities in non-malicious software, and breaches executed by advanced threat actors.

For this and other reasons, there is a need for the present invention.

### SUMMARY

According to an aspect of the specification, a method for detecting vulnerabilities in electronic devices is provided, comprising: storing a suspect application in a memory; storing a plurality of application features in the memory, each application feature defining a behavioural attribute; at a processor connected to the memory, identifying a subset of the application features that define behavioural attributes exhibited by the suspect application; at the processor, selecting one of a vulnerable classification and a non-vulnerable classification for the suspect application based on the identified subset of the application features; when the selected classification is the vulnerable classification: interrupting at least one of the installation and the execution of the suspect application by the processor; and at the processor, generating an alert indicating that the suspect application contains a vulnerability.

### BRIEF DESCRIPTIONS OF THE DRAWINGS

Embodiments of the present invention will now be described by way of example with reference to the accompanying drawings, in which:

FIG. 1 depicts a schematic representation of a front view of an exemplary cyber-physical system device in the form of a smartphone, according to a non-limiting embodiment;

FIG. 2 depicts a block diagram of the electronic components of the device shown in FIG. 1, according to a non-limiting embodiment;

FIG. 3 depicts a block diagram of an exemplary system for detecting vulnerabilities in electronic devices, according to a non-limiting embodiment; and

FIG. 4 depicts a method of detecting vulnerabilities in electronic devices, according to a non-limiting embodiment;

FIG. 5 depicts a payload analysis stage of a method of detecting vulnerabilities in electronic devices, according to a non-limiting embodiment;

FIG. 6 depicts a sandbox monitoring stage of a method of detecting vulnerabilities in electronic devices, according to a non-limiting embodiment;

FIG. 7 depicts a normal monitoring stage of a method of detecting vulnerabilities in electronic devices, according to a non-limiting embodiment;

FIG. 8 depicts a method of processing a vulnerability detection, according to a non-limiting embodiment; and

FIG. 9 depicts a prompt interface generated in the performance of the method of FIG. 8, according to a non-limiting embodiment.

### DETAILED DESCRIPTION OF THE EMBODIMENTS

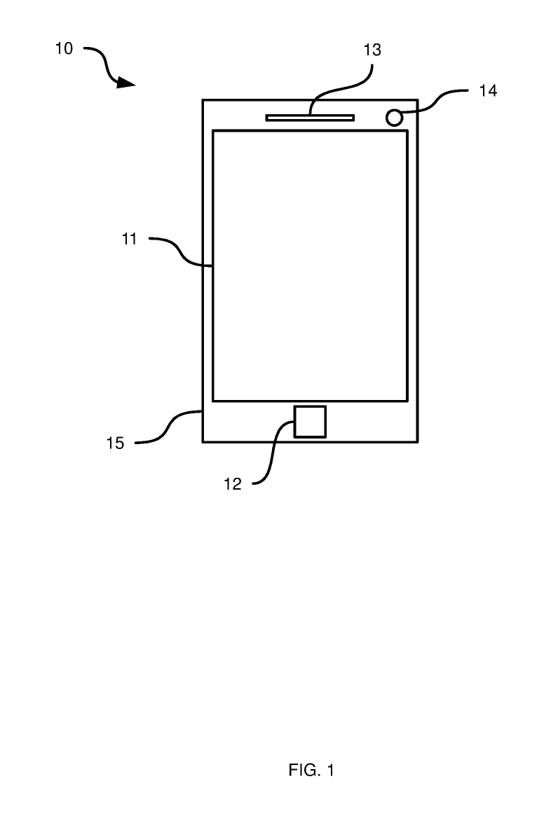

FIG. 1 is a schematic representation of a non-limiting example of a cyber-physical system device 10 which will be monitored to detect and prevent vulnerabilities, such as exploitation or unauthorized access by malicious software and other threats, as discussed in greater detail below. It is to be understood that cyber-physical system device 10 is an example, and it will be apparent to those skilled in the art that a variety of different cyber-physical system device structures are contemplated. Indeed, variations on cyber-physical system device 10 can include, without limitation, a cellular telephone, a refrigerator, an automobile, a camera, a portable music player, a portable video player, a personal digital assistant, a portable book reader, a portable video game player, a tablet computer, a television, an airplane, a train, an industrial control system, a wearable computing device, a desktop telephone, or subsystems thereof. It should be noted that device 10 may also be implemented as a virtual, simulated or emulated device. One skilled in the art will understand that such virtual devices could be used to generate additional data.

Referring to FIG. 1, device 10 comprises a chassis 15 that supports a display 11. Display 11 can comprise one or more light emitters such as an array of light emitting diodes (LED), liquid crystals, plasma cells, or organic light emitting diodes (OLED). Other types of light emitters are contemplated. Display 11 can also comprise a touch-sensitive membrane to thereby provide an input device for device 10. Other types of input devices, other than a touch membrane on display 11, or in addition to a touch membrane on display 11, are contemplated. For example, an input device 12 such as a button can be provided in addition to, or instead of, the above-mentioned touch membrane. In other embodiments, any suitable combination of input devices can be included in device 10, including any one or more of a physical keyboard, a touch-pad, a joystick, a trackball, a track-wheel, a microphone, an optical camera 14, a steering wheel, a switch, an altimeter, an accelerometer, a barometer, an EKG electrode, and the like. In a present implementation, device 10 can also comprise an output device in the form of a speaker 13 for generating audio output (it will now be apparent that display 11 is also a form of output device). Speaker 13 may be implemented as, or augmented with, a wired or wireless headset, or both. Device 10 can also include a variety of other output devices, including any suitable combination of optical, haptic, olfactory, tactile, sonic or electromagnetic output devices.

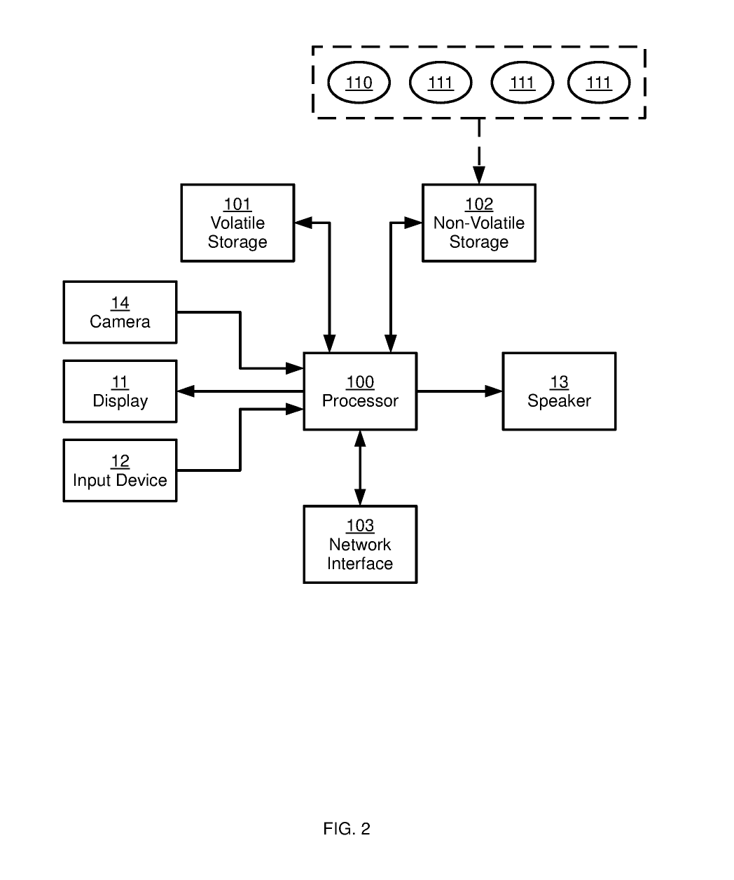

FIG. 2 shows a schematic block diagram of the electronic components of device 10. It should be emphasized that the structure in FIG. 2 is a non-limiting example. Device 10 includes at least one input device 12 which in a present embodiment includes the above-mentioned button shown in FIG. 1. Input device 12 can also include the above-mentioned touch membrane integrated with display 11. As noted above, other input devices are contemplated. Input from input device 12 is received at a processor 100 connected to input device 12. Processor 100 generally includes one or more integrated circuits. In variations, processor 100 may be implemented as a plurality of processors. Processor 100 can be configured to execute various computer-readable programming instructions; the execution of such instructions can configure processor 100 to perform various actions, responsive to input received via input device 12.

To fulfill its programming functions via the execution of the above-mentioned instructions, processor 100 is also configured to communicate with a non-transitory computer readable storage medium, such as a memory comprising one or more integrated circuits. In the present embodiment, the memory includes at least one non-volatile storage unit 102 (e.g., Erasable Electronic Programmable Read Only Memory (“EEPROM”), Flash Memory) and/or at least one volatile storage unit 101 (e.g. random access memory (“RAM”)). Programming instructions that implement the functional teachings of device 10 as described herein are typically maintained, persistently, in non-volatile storage unit 102 and executed by processor 100, which makes appropriate utilization of volatile storage 101 during the execution of such programming instructions.

Processor 100 in turn is also configured to control display 11 and speaker 13 and any other output devices that may be provided in device 10, also in accordance with different programming instructions and responsive to different input received from the input devices.

Processor 100 also connects to a network interface 103, which can be implemented in a present embodiment as a radio configured to communicate over a wireless link, although in variants device 10 can also include a network interface for communicating over a wired link. Network interface 103 can thus be generalized as a further input/output device that can be utilized by processor 100 to fulfill various programming instructions. It will be understood that interface 103 is configured to correspond with the network architecture that defines such a link. Present, commonly employed network architectures for such a link include, but are not limited to, Global System for Mobile communication (“GSM”), General Packet Relay Service (“GPRS”), Enhanced Data Rates for GSM Evolution (“EDGE”), 3G, 4G, Long Term Evolution (LTE), High Speed Packet Access (“HSPA”), Code Division Multiple Access (“CDMA”), Evolution-Data Optimized (“EVDO”), Institute of Electrical and Electronic Engineers (“IEEE”) standard 802.11, Bluetooth, Zigbee, Near-Field Communications (“NFC”) Controller Area Network bus (CAN bus), Modbus, or any of their variants or successors. It is also contemplated each network interface 103 can include multiple radios to accommodate the different protocols that may be used to simultaneously or individually communicate over different types of links.

As will become apparent further below, device 10 can be implemented with different configurations than described, omitting certain input devices or including extra input devices, and likewise omitting certain output devices or including extra input devices.

In a present embodiment, the above-mentioned programming instructions stored in the memory of device 10 include, within non-volatile storage 102, a security application 110 (which can be a stand-alone application or a component integrated into another application) and optionally, one or more additional applications or files 111. Security application 110 and the one or more additional applications or files 111 can be pre-stored in non-volatile storage 102 upon manufacture of device 10, or downloaded via network interface 103 and saved on non-volatile storage 102 at any time subsequent to manufacture of device 10. As will be explained further below, security application 110 can be executed by processor 100 to detect vulnerabilities at device 10, for example in one or more of the other applications 111. Via execution of application 110, processor 100 can also be configured to prevent exploitation or unauthorized access by malicious software and other threats, and to share information or interact with other devices that are also configured to execute their own version of security application 110. Such other devices may be identical to, or variations of device 10, as discussed above.

Processor 100 is configured to execute security application 110, accessing applications or files 111 in non-volatile storage 102, volatile storage 101, display 11, input device 12, camera 14, speaker 13, and network interface 103 as needed. The actions taken by processor 100 through the execution of security application 110 will be described in greater detail below.

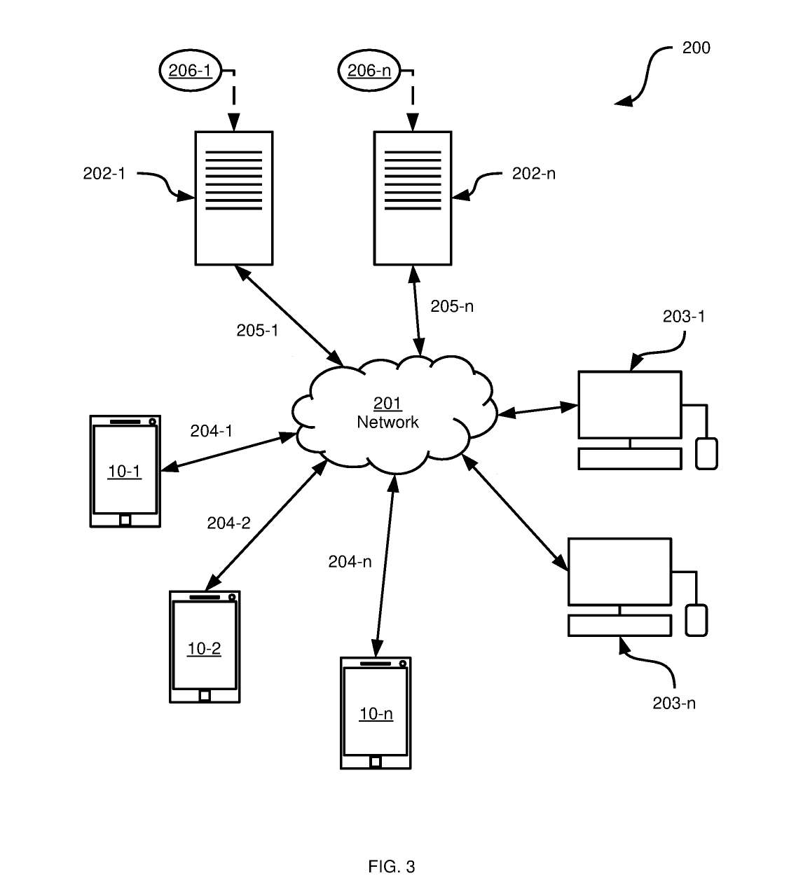

Referring now to FIG. 3, a system for the detection and prevention of exploitation of or unauthorized access to a plurality of connected cyber-physical system devices by malicious software and other threats is indicated generally at 200. System 200 comprises a plurality of devices 10-1, 10-2 . . . 10-n. (Collectively, devices 10 and generically, device 10. This nomenclature is used elsewhere herein.) For illustrative simplicity, each device 10 is shown as identical to device 10 as described above, but each device 10 may have a different configuration from the other, although each device includes security application 110.

Devices 10 each connect to a network 201 or each other via respective links 204-1, 204-2 and 204-n. Network 201 may comprise the Internet or any other type of network topology that enables communications between devices 10. Likewise, each link 204 can comprise any combination of hardware (e.g. various combinations of cabling, antennae, wireless base stations, routers, intermediations servers, etc.) and overlaid communication protocols to enable the connection between respective device 10 and network 201.

System 200 also comprises at least one server 202-1 . . . 202-n that also connects to network 201 or each other via respective links 205-1 and 205-n. Each server 202 can be implemented on physical hardware, or can be implemented in a cloud computing context as a virtual server (which, as will now be apparent to those skilled in the art, would be provided by virtualization programming instructions executed by physical hardware). In any event, those skilled in the art will appreciate that an underlying configuration of interconnected processor(s), non-volatile storage, and network interface(s) are used to implement each server 202. Each server is configured to execute a security analysis program 206. Each security analysis program 206 can be based on similar or different underlying security analysis programs. Note that while security analysis program 206 is contemplated to be executing on a server 202 that is separate from any of the devices 10, in variations, it is contemplated that the security analysis program 206 could be implemented in one or more of the devices 10 and thereby obviate the servers 202 altogether.

Security analysis program 206 can be based, entirely or in part, on existing third-party security analysis programs, additional information about malicious or benign files or applications 111 may be provided. For example, the hash signature of an application may be recognized as malicious. System 200 may also comprise other computer systems 203-1 . . . 203-n which may be used for the purposes of reviewing reports and managing devices. It is considered that devices 10 may also be implemented in a virtual environment, emulated or simulated within servers 202 or computers 203. In other embodiments, servers 202 can execute security application 110 on behalf of devices 10, as will be discussed below.

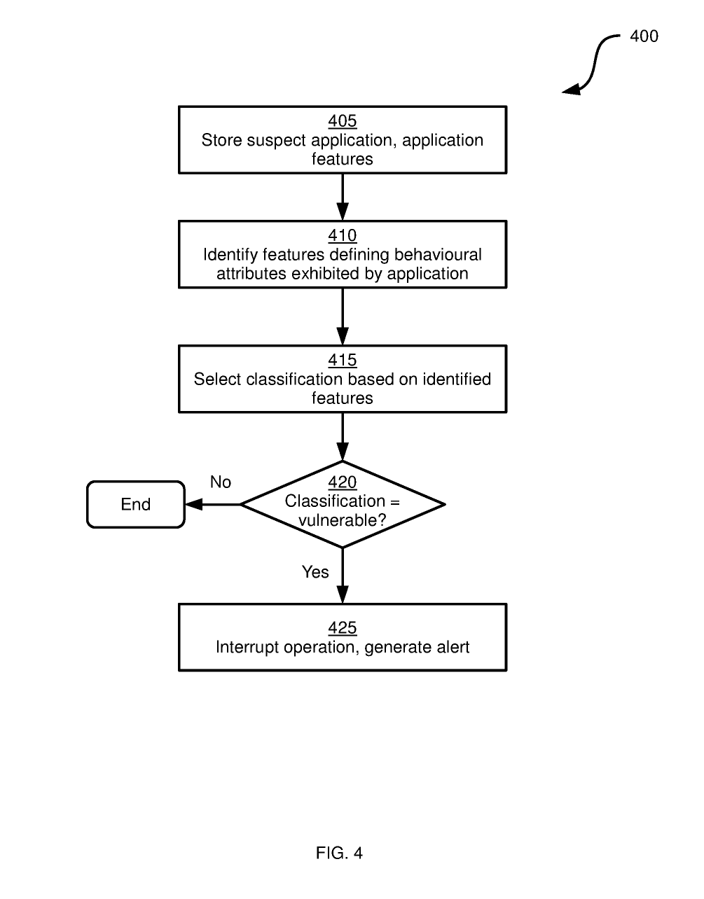

Referring now to FIG. 4, a method 400 of detecting vulnerabilities in electronic devices is illustrated. Method 400 will be described in conjunction with its performance within system 200, and particularly on a device 10 (e.g. device 10-1). That is, the blocks of method 400, in the present embodiment, are performed by device 10 via the execution of security application 110 by processor 100, in conjunction with the other components of device 10. In other embodiments, method 400 can be performed by other devices, including servers 202. For example, as will be noted later herein, servers 202 can perform at least a portion of method 400 on behalf of devices 10.

Beginning at block 405, device 10 is configured to store an application, referred to herein as a “suspect application”. A suspect application can be any of a wide variety of applications, such as one of applications 111 mentioned above, that may contain vulnerabilities. In other words, a suspect application is an application that has not yet been verified as free of vulnerabilities by security application 110. The mechanism by which the suspect application is stored is not particularly limited. For example, the suspect application can be received at device 10 via network 201 (e.g. in response to a request for the suspect application issued by device 10).

Block 405 also includes storing a plurality of application features. In the present example performance of method 400, the application features are stored in non-volatile storage 102. The application features can be a component of security application 110, or can be a separate database that processor 100 is configured to access during the execution of security application 110 (that is, during the performance of method 400).

Each of the application features stored in non-volatile storage 102 defines a behavioural attribute of an application. In general, a behavioural attribute can be an element of an application (e.g. a string of code in the programming instructions that comprise the application, identifying a certain domain or causing processor 100 to execute a certain algorithm), referred to as a behavioural attribute because the element, when executed by processor 100, causes certain behaviour to be exhibited by device 10. A behavioural attribute of an application can also be a behaviour exhibited by device 10 via the execution of the application (e.g. high utilization of processor 100, or the transmission of messages to a certain domain). The application features stored at block 405 can define any suitable number of either or both of the above types of behavioural attributes. Various examples of application features and the behavioural attributes they define will be discussed below.

Proceeding to block 410, device 10 is configured (again, via the execution of security application 110), to identify a subset of the above-mentioned application features that define behavioural attributes exhibited by the suspect application. In other words, processor 100 is configured to compare the suspect application, or various operational parameters of device 10 during the execution of the suspect application, or both, to the application features to determine which application features are exhibited by the suspect application. For example, a first one of the application features may define a first behavioural attribute in the form of a string identifying a certain domain (e.g. “malware.com”). The suspect application, upon examination by processor 100 via the execution of security application 110, may not contain such a string. Therefore, the suspect application does not exhibit the first behavioural attribute. On the other hand, a second one of the application features may define a second behavioural attribute in the form of elevated processor utilization during execution of the suspect application (e.g. utilization of over 80% by the suspect application). When execution of the suspect application reveals high processor utilization, the suspect application is said to exhibit that second behavioural attribute. The second application feature (or an identifier thereof) is therefore among the subset identified at block 410.

At block 415, having identified a subset of application features that match the suspect application (that is, features defining behavioural attributes exhibited by the suspect application), processor 100 is configured to select a classification for the suspect application based on the subset of application features identified at block 410. In the present embodiment, the classification selected is one of a vulnerable classification and a non-vulnerable classification. A vulnerable classification indicates that the suspect application exposes device 10, either through direct action or by enabling direct action by other applications, to unauthorized access by malicious software and other threats. That is, a suspect application that is classified as vulnerable may be so classified because it is deemed likely to be malicious itself, or because it is not deemed malicious but may inadvertently expose device 10 to compromise by other malicious applications.

The classification performed at block 415 can be based on any of a wide variety of known classification mechanisms. In the present embodiment, security application 110 includes a linear classifier, and thus at block 415, processor 100 is configured to execute the linear classifier. For example, security application 110 can include a weighting factor assigned to each of the application features stored at block 405. At block 415, processor 100, via execution of the linear classifier, can be configured to generate the dot product of a vector comprising the subset of features identified at block 410 with a weight vector comprising the weights for that subset of features. Thus, processor 100 can be configured to generate a single value, representing a vulnerability score, based on the subset of features and the above-mentioned weights. Processor 100 can then be configured to compare the score to a predetermined threshold, and to select the vulnerable class if the score exceeds the threshold, and to select the non-vulnerable class if the score does not exceed the threshold.

As noted above, other forms of classification may also be employed. For example, processor 100 can be configured to select a class based on a decision tree included in security application 110. In further embodiments, the classifier can be a Bayesian classifier, a neural network classifier, one or more genetic algorithms, or any other suitable classifier. In still other embodiments, security application 110 can include a plurality of classifiers. Processor 100, in such embodiments, can be configured to execute each classifier, and thus select a plurality of classes (one per classifier) for the suspect application. Processor 100 can then be configured to combine the selected classes (e.g. through a voting or weighting mechanism) to yield the class selected at block 415.

As will be discussed in greater detail below, processor 100 can also be configured to optimize the classification mechanism, or mechanisms, employed to perform block 415. Such optimization can be performed through the execution by processor 100 of any suitable machine learning process. In general, such processes involve storing a training data set including a plurality of feature subsets and corresponding class identifiers. The machine learning process includes generating and optimizing one or more classifiers whose parameters result in the selection of the correct class when block 415 is performed on the training data set. Taking the above-mentioned linear classifier as an example, the learning process involves optimizing the weights assigned to various features in order to arrive at scores for the training feature subsets that match the known correct class of each training subset (or of a sufficiently large portion of the training subset).

At block 420, processor 100 is configured to determine whether the classification selected at block 415 indicates that the suspect application is considered vulnerable. When the determination is negative (that is, when the selected class is non-vulnerable), the performance of method 400 can end. In other embodiments, the performance of method 400 need not end following a determination that the suspect application has been classified as non-vulnerable. For example, processor 100 can be configured to perform various other activities, including transmitting a message to another device (such as a server 202), generating a prompt on display 11, and the like. When the determination at block 420 is affirmative, however, the performance of method 400 can proceed to block 425.

At block 425, processor 100 can be configured to interrupt an operation of device 10, and to generate an alert. The operation interrupted at block 425 can include, for example, the installation of the suspect application (in some embodiments, the performance of method 400 can be initiated in response to an attempted installation of the suspect application). The operation interrupted at block 425 can also include the execution of the suspect application (if the suspect application has previously been installed).

The alert generated at block 425 can be any one of, or any combination of, a variety of alerts. For example, processor 100 can be configured to present a prompt on display 11 requesting input data to override the above-mentioned interruption or sustain the interruption. In addition to the prompt, or instead of the prompt, processor 100 can be configured to transmit a message to a server 202 including, for example, an identifier of the suspect application (e.g. a cryptographic hash of at least a portion of the suspect application) and an indication that the application is vulnerable. In other embodiments, processor 100 can be configured to generate the alert by adding an entry to a log stored in non-volatile storage 102 instead of, or in addition to, transmitting the above-mentioned message and presenting the above-mentioned prompt.

As noted earlier, the performance of method 400 need not end after a negative determination at block 420. For example, the generation of an alert can be performed following the negative determination, with the exception that the alert indicates that no vulnerability was found in the suspect application.

As discussed in connection with blocks 405 and 410, the application features stored in non-volatile storage 102 can define elements of an application (though a given suspect application under examination does not necessarily contain those elements), behaviours caused by the application, or a combination thereof. In the present embodiment, processor 100 is configured to implement blocks 410 and 415 in a plurality of stages, and the application features are divided within non-volatile storage 102 according to those stages. More specifically, in the present example processor 100 is configured to perform at least one of a payload analysis stage associated with the installation of the suspect application; a sandboxed monitoring stage; and a normal monitoring stage. Those will be discussed in greater detail below. As described below, the stages can be performed in sequence. In other embodiments, however, the stages can be performed in other sequences, or independently from each other.

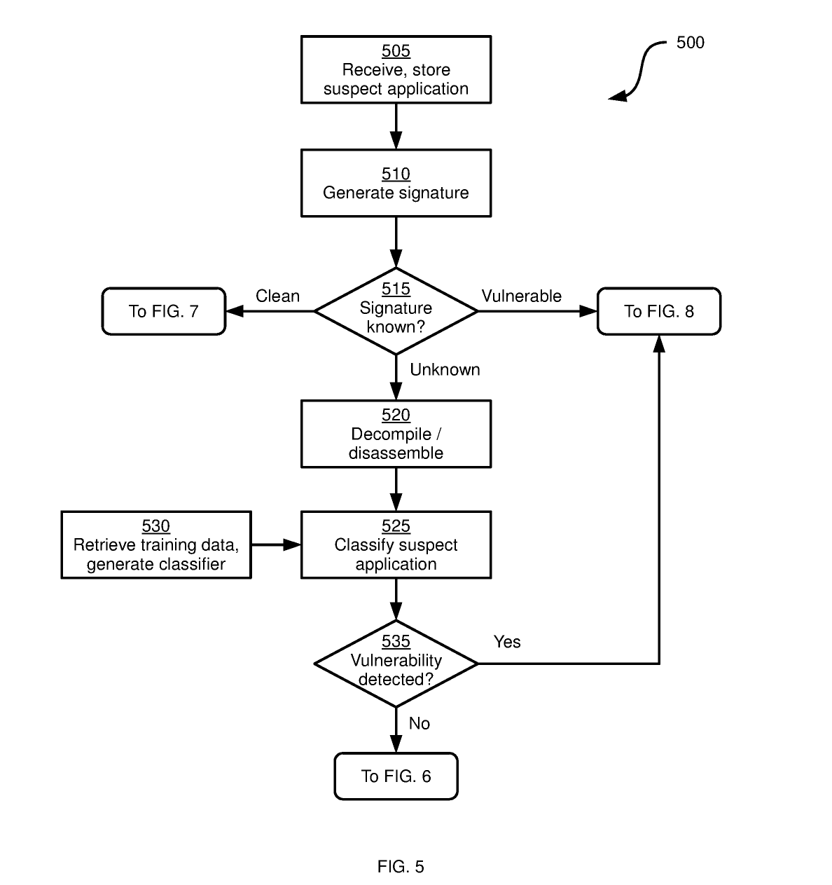

Referring now to FIG. 5, a method 500 of detecting vulnerabilities in electronic devices is depicted. Method 500 will be described in conjunction with its performance within system 200, and particularly on a device 10 (e.g. device 10-1). That is, the blocks of method 500, in the present embodiment, are performed by device 10 via the execution of security application 110 by processor 100, in conjunction with the other components of device 10. In other embodiments, method 500 can be performed by other devices, including servers 202. Method 500 represents above-mentioned payload analysis stage, and thus represents an instance of method 400 that can be combined with other instances (e.g. other stages).

At block 505, device 10 is configured to receive a suspect application, and store the suspect application in non-volatile storage 102 (thus performing block 405 of method 400). The suspect application received and stored at block 505 can be a new application, or an updated version of an application previously installed on device 10. The suspect application can be received from any of a variety of sources (e.g. a server 202 or any other computing device connected to network 201; local storage media such as a USB key; and the like).

At block 510, responsive to receiving the suspect application, device 10 (and more particularly, processor 100 executing security application 110) is configured to generate a signature from the suspect application (either from the entire suspect application, or a portion thereof). Any suitable signature generation process may be employed at block 510. For example, device 10 can generate the signature using a mathematical function such as a hash algorithm (e.g. MD5 or SHA-1).

At block 515, having generated the signature, device 10 is configured to retrieve a list of known signatures (either from memory such as non-volatile storage, or via network 201) and compare the signature from block 510 to the list. The list retrieved at block 515 indicates, for each of a plurality of known signatures, whether that signature represents a vulnerable (e.g. malicious) application or a non-vulnerable (e.g. benign) application. Based on the comparison at block 515, device 10 is configured to determine whether the suspect application is “clean” (that is, non-vulnerable), vulnerable, or unknown (that is, not accounted for in the list of known signatures).

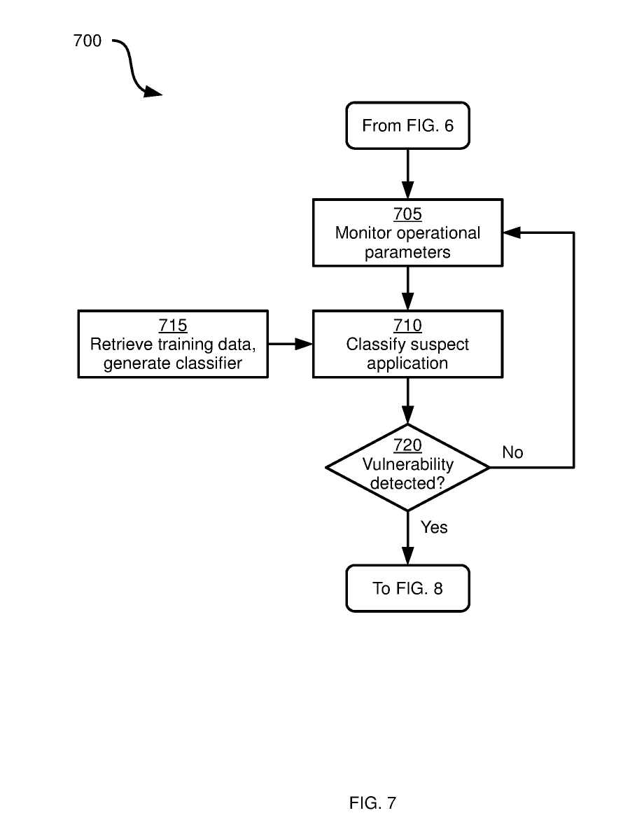

When device 10 determines at block 515 that the suspect application's signature (generated at block 510) matches a signature representing an application known to be clean, the installation or updating of the suspect application can be allowed to proceed. Processor 100 can then be configured to monitor various operational parameters of device 10, as will be discussed in connection with FIG. 7. In other embodiments, the performance of method 500 can simply terminate after a “clean” determination at block 515.

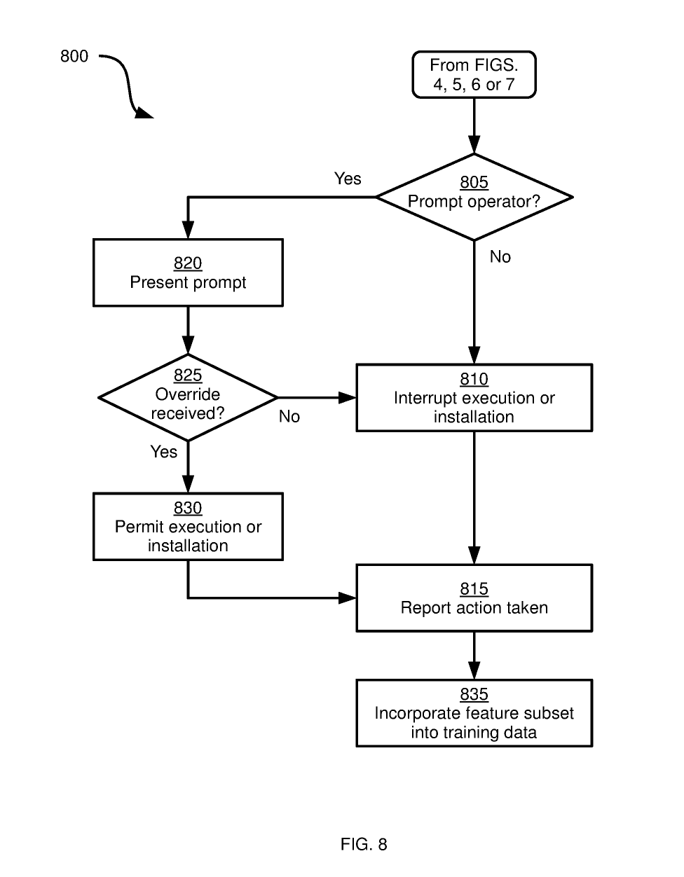

If the determination at block 515 is that the suspect application has a signature matching a signature in the retrieved list that is known to represent a vulnerable or malicious application, device 10 can be configured to generate any of a variety of forms of alert, for example to the operator of device 10. Alert generation will be discussed below, in connection with FIG. 8.

When the determination at block 515 is inconclusive—that is, when the signature generated at block 510 does not match any signature in the retrieved list of known signatures—the performance of method 500 proceeds to block 520. At block 520, device 10 can be configured to decompile or disassemble the suspect application via the execution of any suitable decompiler.

As a result of the performance of block 520, device 10 stores, in memory such as non-volatile storage 102, source code, byte code or a combination thereof, derived from the suspect application received at block 505. Responsive to decompiling or disassembly of the suspect application, device 10 is configured, at block 525, to classify the suspect application. It will now be apparent that the performance of block 525 represents a performance of blocks 410 and 415 as discussed above.

Thus, device 10 is configured at block 525 to identify a subset of features defining behavioural attributes exhibited by the suspect application, and to select a class (vulnerable, or non-vulnerable) for the suspect application based on the identified subset of features. In the present example, the features referred to by processor 100 at block 525 include elements of an application, such as strings of text (e.g. source code or byte code), identifiers of permissions (that is, identifiers of resources within device 10 to which the suspect application will be granted access if installed), and the like. The above-mentioned strings can include, for example, a list of domains known to be associated with malicious applications; various commands including, for example, commands modifying certain system resources that are not expected to be modified under normal circumstances, and the like. Further examples of features employed at this tage include features defining the manner in which commands in the suspect application are written. For example, the features can include the presence of any one or more of cryptographic code, reflection code, privacy endangering attributes, commands that transmit SMS messages, commands that expose data stored on device 10 that identifies device, the location of device 10, the operator of device 10 (e.g. personally identifying information), or any combination thereof.

As discussed above in connection with FIG. 4, processor 100 is configured to identify which of the application features are exhibited by the suspect application, and to select a class. As mentioned earlier, the class can be selected via the generation of a vulnerability score and the comparison of the score to a predetermined threshold, or any other suitable classification process that will occur to those skilled in the art.

In some embodiments, prior to the performance of block 525, device 10 can be configured to perform block 530. At block 530, a set of data can be retrieved (e.g. from non-volatile storage 102 or via network 201), including a plurality of feature subsets previously identified in other suspect applications. The data set retrieved at block 530 also includes a class identifier for each subset. In other words, the set of data retrieved at block 530 represents a plurality of performances of block 525 for applications other than the suspect application received at block 505. This data set is referred to as a training data set. Device 10 can then be configured to generate classification parameters based on the training data set, employing any suitable machine learning processes that will occur to those skilled in the art. In brief, the machine learning process can involve selecting and optimizing parameters such as the above-mentioned weights such that the resulting parameters lead to the correct classification of a substantial portion (up to and including the entirety) of the feature subsets in the training data set. Block 530 can be performed prior to each performance of block 525, or at less frequent intervals. In some embodiments, block 530 can be performed once, prior to the installation of security application 110, and then omitted from any future performances of method 500 (in other words, the classification employed in method 500 need not necessarily be capable of learning).

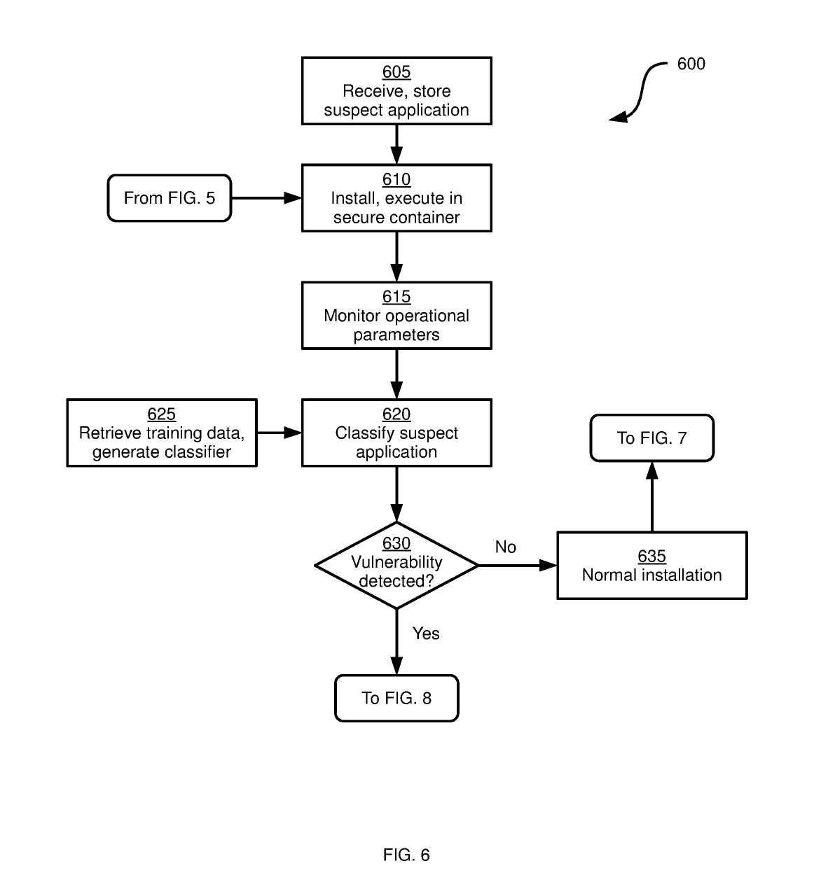

At block 535, processor 100 is configured to determine whether the classification selected at block 525 indicates that the suspect application is vulnerable. In other words, the performance of block 535 is equivalent to the performance of block 420, discussed above in connection with FIG. 4. When the determination at block 535 is negative (that is, when the non-vulnerable classification is selected at block 535), device 10 is configured to proceed to FIG. 6. In other embodiments, device 10 can instead be configured to permit the normal installation of the suspect application, and proceed to FIG. 7.

When the determination at block 535 is affirmative, processor 100 can be configured to proceed to FIG. 8 for alert generation and interruption of the installation or operation of the suspect application.

Referring now to FIG. 6, a method 600 of detecting vulnerabilities in electronic devices, such as device 10, is depicted. As with methods 400 and 500, method 600 will be discussed in connection with its performance on device 10, although it is contemplated that method 600 can be performed on other devices in some embodiments. Method 600 represents another instance of method 400; in particular, method 600 represents the sandboxed monitoring stage mentioned earlier in connection with FIG. 4.

At block 605, device 10 is configured to receive and store a suspect application, as described above in connection with block 505. At block 610, processor 100 is configured to install the suspect application in a secure container, or partition, established within non-volatile storage unit 102. When method 600 is performed in response to, for example, a negative determination at block 535, block 605 can be omitted (since the suspect application has already been received and stored at block 505).

At block 615, having installed the suspect application in a secure container, processor 100 is configured to execute the suspect application, and via simultaneous execution of security application 110, to monitor a plurality of operational parameters of device 10. In particular, the operational parameters monitored are those associated with the execution of the suspect application.

A wide variety of operational parameters can be monitored by processor 100 at block 615. For example, the operational parameters monitored can include any suitable combination of memory access parameters, file access parameters, network traffic parameters, processor utilization parameters, system integrity parameters, and peripheral device parameters. Certain examples of operational parameters are discussed below. In general, processor 100 is configured to capture one or more values for each monitored parameter, and to store the captured values in memory (either in non-volatile storage 102 or volatile storage 101) with an identifier of the application associated with the parameters. Thus, for example, when the suspect application requests access to a particular file, the file access request can be stored in memory along with an identifier of the suspect application.

Examples of memory access parameters collected at block 615 include memory addresses, access times and durations, contents of the accessed memory, the size (e.g. in bytes) of the content, read requests, write requests and execution requests. One skilled in the art will appreciate that other information regarding how memory is accessed may also be monitored.

Examples of file access parameters collected at block 615 include file types, file contents, access times, access durations, latency (that is, the time between the file access request and the file access completion), read requests, write requests and execution requests. One skilled in the art will appreciate that other information regarding how the file system is accessed may also be monitored.

Examples of network traffic parameters collected at block 615 include origin addresses or domain names (or both), destination addresses or domain names (or both), intermediary addresses or domain names (or both), transmission contents, signal strength, latency, and transmission times. One skilled in the art will appreciate that other network traffic information may also be monitored.

Examples of processor utilization parameters collected at block 615 include the temperature of processor 100, the time required to execute operations, the number of cycles required to execute operations, the contents of memory registers on processor 100, a state of processor 100, the number and type of processes being run, and the like. One skilled in the art will appreciate that other information regarding the activity of processor 100 may also be monitored.

Examples of system integrity parameters collected at block 615, include an indication of whether device 10 has been rooted (that is, whether the operator and operator-installed applications have been granted root-level access in device 10, which is frequently not granted by the device manufacturer), and/or whether the device configuration and state as detected matches the configuration and state as reported by the system. One skilled in the art will appreciate that other information regarding system integrity may also be monitored.

Examples of peripheral device parameters collected at block 615 include indications of the presence or absence of various peripheral devices (e.g. cameras, displays, GPS modules, sensors, microphones, speakers, motors, servos, antennae, batteries, and the like). Further examples include the subsystem address of peripheral devices, temperature of peripheral devices or subsystems thereof, identifiers of processes accessing the peripheral devices, the current state of any given peripheral device, and the like. One skilled in the art will appreciate that other information regarding peripherals or subsystems may also be monitored.

The monitored operational parameters are stored in memory, and at block 620, processor 100 is configured to classify the suspect application. It will now be apparent that the performance of block 620 represents a performance of blocks 410 and 415 as discussed above. Processor 100 can be configured to perform block 620 when the volume of monitored parameters that has been collected via block 615 has reached a threshold, or to perform block 620 at predetermined intervals.

Therefore, at block 620 processor 100 is configured to identify a subset of features defining behavioural attributes exhibited by the suspect application, and to select a class (vulnerable, or non-vulnerable) for the suspect application based on the identified subset of features. The identification of features exhibited by the suspect application involves a comparison, by processor 100, of the operational parameters at block 615 associated with the suspect application with application features defining behaviours caused by applications. The application features retrieved and employed for classification at block 620 can define behavioural attributes such as processor utilization (for example, a threshold level of utilization, where the feature is considered present if monitored processor utilization exceeds the threshold), memory access (for example, a specific block of memory addresses, where the feature is considered present if the suspect application attempts to access an address within the block), and the like. More generally, the application features define thresholds or target values for any of the monitored operational parameters.

Having identified a subset of application features exhibited by the suspect application (in particular, via the execution of the suspect application), processor 100, as discussed in connection with FIG. 4, is then configured to select from the vulnerable and non-vulnerable classifications for the suspect application based on the identified subset of application features. For instance, the above-mentioned scoring mechanism can be employed to select a classification.

In addition, as discussed above in connection with block 530, processor 100 can also be configured to retrieve a training data set at block 625, including sets of features corresponding to operational parameters, and corresponding classifications for the sets of features. Processor 100 can then be configured to generate or optimize classification parameters for use at block 620, based on the training data set.

At block 630, processor 100 is configured to determine whether a vulnerability has been detected, based on the classification selected at block 620. The determination at block 630 is as described above in connection with block 525. When the determination at block 630 is affirmative (that is, the classification selected at block 620 for the suspect application indicates that the suspect application is vulnerable), processor 100 can be configured to proceed to FIG. 8 for alert generation and interruption of the installation or operation of the suspect application. When the determination at block 630 is negative, on the other hand, processor 100 can be configured to proceed with the normal installation of the suspect application in non-volatile storage 102 (as opposed to the installation in a secure partition at block 610). The installation can be preceded, in some embodiments, by the generation of a prompt on display 11 requesting that the operator of device 10 confirm that the installation should proceed. Processor 100 can then be configured to proceed to FIG. 7 to monitor various operational parameters of device 10 in conjunction with the execution of the suspect application.

Referring now to FIG. 7, a method 700 of detecting vulnerabilities in electronic devices, such as device 10, is depicted. As with methods 400, 500, and 600, method 700 will be discussed in connection with its performance on device 10, although it is contemplated that method 700 can be performed on other devices in some embodiments. Method 700 represents a further instance of method 400; in particular, method 700 represents the normal monitoring stage mentioned earlier in connection with FIG. 4.

Method 700 is illustrated in FIG. 7 as following the performance of method 600 (specifically, following the performance of block 635, as shown in

FIG. 6). However, in some embodiments, method 700 can also be performed independently of method 600.

At block 705, processor 100 is configured to monitor various operational parameters of device 10 during the execution of the suspect application. The monitoring performed at block 705 is as described above in connection with block 615. Thus, at block 705 processor 100 can be configured to capture and store any suitable combination of the operational parameters mentioned above, at any suitable resolution and frequency, and store the captured parameters along with an identifier of the application associated with such parameters. For example, processor 100 can be configured to store a plurality of processor utilization values (e.g. percentages). Each value can be stored along with an identifier of the application responsible for that usage. In other words, the monitoring at block 705 can be employed to monitor a plurality of applications executed by processor 100.

At block 710, processor 100 is configured to classify the monitored applications. That is, the monitored parameters collected at block 615 may contain parameters associated with one or more applications. At block 710, processor 100 thus classifies each of the applications identified in the collected monitoring parameters. For each application classified at block 710, the classification process is as described above, for example in connection with block 625. Processor 100 can be configured to perform block 710 when the volume of monitored parameters that has been collected via block 705 has reached a threshold, or to perform block 710 at predetermined intervals.

At block 720, processor 100 is configured to determine whether a vulnerability has been detected, based on the classification selected at block 710. The determination at block 720 is as described above in connection with blocks 535 and 630 (and represents another instance of a performance of block 420, shown in FIG. 4). When the determination at block 720 is negative, the performance of method 700 can return to block 705 to continue monitoring the operational parameters of device 10. In other words, processor 100 can be configured to repeat the performance of method 700 until a vulnerability is detected. In some embodiments, the performance of method 700 can also be interrupted upon receipt of a new suspect application to install, at which point method 500, or method 600, or both, can be performed as described above.

When the determination at block 720 is affirmative, processor 100 is configured to proceed to FIG. 8 for alert generation and interruption of the installation or operation of the application classified as vulnerable at block 710. FIG. 8 will be described below.

Referring now to FIG. 8, a method 800 of processing a vulnerability detection (as detected in any of methods 400, 500, 600 and 700) is depicted. Method 800 will be described in conjunction with its performance by device 10, although as noted above, method 800 can also be performed by other devices in system 200.

At block 805, following an affirmative determination at any of blocks 420, 535, 630, and 720, processor 100 can be configured to determine whether to prompt the operator of device 100 for instruction on handling the vulnerability detection. When the determination at block 805 is negative, processor 100 does not prompt the operator, although processor 100 can be configured, in some embodiments, to control display 11 to generate a notification that a vulnerable application has been detected. Following such a notification (if employed), processor 100 is configured to perform block 810.

At block 810, processor 100 is configured to automatically interrupt the execution or installation of the application detected as being vulnerable. Following interruption of the vulnerable application, processor 100 can be configured to report any action taken (i.e., the interruption of the vulnerable application, in the present example). The nature of the report at block 815 is not particularly limited. For example, processor 100 can be configured to store an indication of the action taken, along with an identifier of the affected application, in non-volatile storage 102. In other embodiments, processor 100 can be configured to send, instead of or in addition to local reporting, a message to a server 202 containing the action taken and the identifier of the affected application.

A wide variety of other reporting actions are also contemplated. At block 815 processor 100 can also report additional information concerning the affected application. For example, processor 100 can be configured to report (e.g. store locally, transmit to servers 202, or both) the identified feature subset for the affected application. In other embodiments, processor 100 can be configured to report such information even in cases where an application is classified as non-vulnerable.

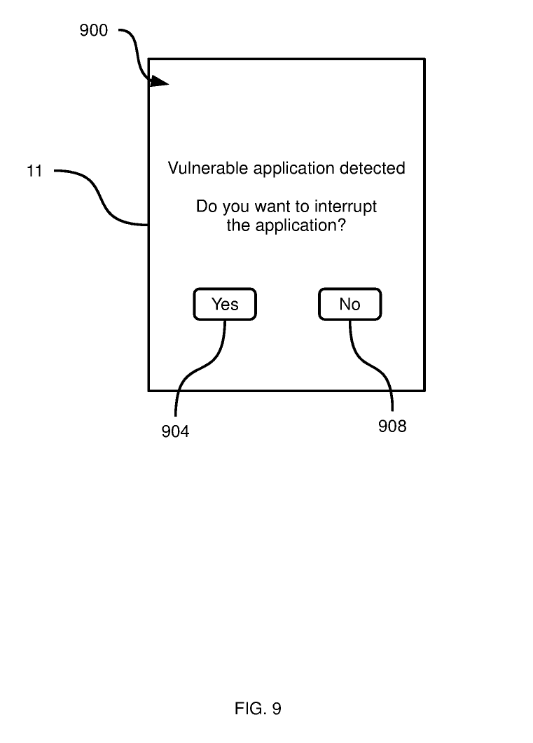

When the determination at block 805 is affirmative—for example, when security application 110 contains a predetermined setting indicating that the operator is to be prompted in response to any vulnerable classification—at block 820, processor 100 is configured to control display 11 to present a prompt requesting confirmation or denial of the interruption of the application classified as vulnerable. An example prompt 900 presented on display 11 is shown in FIG. 9. Prompt 900 includes selectable elements 904 and 908 for confirming the interruption of the vulnerable application (904) and denying, or overriding, the interruption (908).

Returning to FIG. 8, at block 825, processor 100 is configured to determine whether input data defining an override command has been received. For example, the determination at block 825 can be a determination of whether selectable element 908 has been received. When the determination at block 825 is negative (e.g. selectable element 904 was selected, or no input was received in response to the prompt), the performance of method 800 proceeds to block 810, as discussed earlier.

When the determination at block 825 is affirmative, however, processor 100 is configured to permit the continue execution or installation of the application classified as vulnerable, at block 830. The performance of method 800 then proceeds to block 815. When an override has been received, the performance of block 815 can include a report that the original classification for the affected application was the vulnerable classification, but that the original classification was overridden.

In some embodiments, processor 100 can also be configured to incorporate the feature subset employed in the classification of the affected application into the above-mentioned training datasets. In the present example, block 835 is performed when an override is received at block 825, as an override may indicate that the classification was incorrect. Thus, the feature subset that led to the incorrect vulnerable classification can be added to a training data set with a non-vulnerable classification, for use in generating further optimized classification parameters (e.g. at block 530).

In other embodiments, block 835 can be performed only when the override command is received from a sufficiently reliable source. For example, when device 10 is configured to perform block 815 by reporting data to a server 202, the server 202 can be configured to incorporate a given feature subset into training datasets only when a threshold number of devices 10 have reported overrides for that feature subset, or when a device 10 with at least a threshold trust level has reported an override.

When incorporating a feature subset into training data sets, device 10 or server 202 can also be configured to generate a plurality of variations of the affected application, perform feature identification on those variations, and incorporate the feature subsets of the variations into the training data sets (with the same classification as the feature subset of the original application). The variations can be generated based on any suitable combination of known obfuscation techniques that are employed to conceal malicious commands in applications.

Variations to the above systems and methods are contemplated. For example, the identification of feature subsets and the classification processes discussed above may also be applied to data other than executable applications, such as images, audio, video and the like.

In further variations, as mentioned earlier, the methods described herein can be performed in part or in whole at servers 202 rather than at devices 10. For example, device 10 can be configured to transmit applications, monitored operational parameters and the like to a server 202, and server 202 can be configured to perform the feature subset identification and classification procedures described above. Thus, the above-mentioned application features for comparison with the suspect application can be stored at servers 202, rather than at devices 10. In such embodiments, in response to receiving data (e.g. an application, monitoring data or the like) from device 10, server 202-1 can be configured to transmit a message to device 10 including an identification of the classified application and the selected classification.

In other embodiments, the methods described herein can be performed at device 10, by a dedicated processor separate from processor 100, such as a field-programmable gate array (FPGA), an application specific integrated circuit (ASIC), or the like.

In further embodiments, the above-mentioned stages of monitoring and classification can be performed in different sequences than those discussed. For example, when the determination at block 535 is negative, processor 100 can be configured to proceed to the normal monitoring stage shown in FIG. 7, rather than the sandbox monitoring stage of FIG. 6. Various other rearrangements of the above-mentioned stages will also occur to those skilled in the art.

In still further embodiments, when devices 10 report data to servers 202 at block 815, other computing devices, such as computer system 203, can be configured to retrieve such data for viewing, for example via conventional web browsers. Further variations to the above embodiments will also occur to those skilled in the art.

The scope of the claims should not be limited by the embodiments set forth in the above examples, but should be given the broadest interpretation consistent with the description as a whole.

1. A method for detecting vulnerabilities in electronic devices, comprising:
storing a suspect application in a memory;
storing a plurality of application features in the memory, each application feature defining a behavioural attribute;
at a processor connected to the memory, identifying a subset of the application features that define behavioural attributes exhibited by the suspect application;
at the processor, selecting one of a vulnerable classification and a non-vulnerable classification for the suspect application based on the identified subset of the application features;
when the selected classification is the vulnerable classification:
interrupting at least one of the installation and the execution of the suspect application by the processor; and
at the processor, generating an alert indicating that the suspect application contains a vulnerability.

2. The method of claim 1, wherein the behavioural attributes defined by the application features include at least one of application elements and electronic device behaviours.

3. The method of claim 2, wherein the application elements include at least one of code strings, permissions identifiers, and resource identifiers.

4. The method of claim 2, wherein the electronic device behaviours include at least one of memory access parameters, file access parameters, network traffic parameters, processor utilization parameters, system integrity parameters, and peripheral device parameters.

5. The method of claim 1, wherein selecting one of the vulnerable classification and the vulnerable classification comprises:
generating a score based on the identified subset of application features; and
comparing the score to a predetermined threshold.

6. The method of claim 5, further comprising selecting the vulnerable classification when the score exceeds the predetermined threshold.

7. The method of claim 5, wherein generating the score includes combining the identified subset of application features with a plurality of weighting factors corresponding to the application features.

8. The method of claim 1, wherein generating an alert comprises:
determining whether to prompt an operator of the electronic device; and
when the determination is affirmative, controlling a display to generate a prompt including a selectable override element.

9. The method of claim 8, further comprising:
determining whether the override element has been selected; and
when the determination is affirmative, resuming the installation or execution of the suspect application.

10. The method of claim 1, further comprising:
storing the selected classification in the memory with an identifier of the suspect application.

11. An electronic device, comprising:
a memory storing a suspect application and a plurality of application features, each application feature defining a behavioural attribute;
a processor connected to the memory, the processor configured to:
identify a subset of the application features that define behavioural attributes exhibited by the suspect application;
select one of a vulnerable classification and a non-vulnerable classification for the suspect application based on the identified subset of the application features;
when the selected classification is the vulnerable classification:
interrupt at least one of the installation and the execution of the suspect application by the processor; and
generate an alert indicating that the suspect application contains a vulnerability.

12. The electronic device of claim 11, wherein the behavioural attributes defined by the application features include at least one of application elements and electronic device behaviours.

13. The electronic device of claim 12, wherein the application elements include at least one of code strings, permissions identifiers, and resource identifiers.

14. The electronic device of claim 12, wherein the electronic device behaviours include at least one of memory access parameters, file access parameters, network traffic parameters, processor utilization parameters, system integrity parameters, and peripheral device parameters.

15. The electronic device of claim 11, the processor configured to select one of the vulnerable classification and the vulnerable classification by:
generating a score based on the identified subset of application features; and
comparing the score to a predetermined threshold.

16. The electronic device of claim 15, the processor further configured to select the vulnerable classification when the score exceeds the predetermined threshold.

17. The electronic device of claim 15, the processor configured to generate the score by combining the identified subset of application features with a plurality of weighting factors corresponding to the application features.

18. The electronic device of claim 11, the processor configured to generate an alert by:
determining whether to prompt an operator of the electronic device; and
when the determination is affirmative, controlling a display to generate a prompt including a selectable override element.

19. The electronic device of claim 18, the processor further configured to:
determine whether the override element has been selected; and
when the determination is affirmative, resume the installation or execution of the suspect application.

20. The electronic device of claim 11, the processor further configured to:
store the selected classification in the memory with an identifier of the suspect application.
